(19) United States
(12) Patent Application Publication
(10) Pub. No.: US 2025/0326255 A1
(43) Pub. Date: Oct. 23, 2025

(54) TYRE FOR BIG ENDURO MOTORCYCLES

(71) Applicant: Pirelli Tyre S.p.A., Milano (IT)

(72) Inventors: Giuliano BONACCORSI, Milano (IT); Matteo TORCHIANA, Milano (IT); Luca NAPOLITANO, Milano (IT); Marianna ZINNA, Milano (IT)

(73) Assignee: Pirelli Tyre S.p.A., Milano (IT)

(21) Appl. No.: 18/868,315

(22) PCT Filed: May 31, 2023
(86) PCT No.: PCT/IB2023/055558

§ 371 Date: Nov. 22, 2024

(30) Foreign Application Priority Data
Jun. 1, 2022 (IT) 102022000011684

(51) Int. Cl. B60C 11/00; B60C 1/00; B60C 11/03; B60C 11/11

(52) U.S. Cl. CPC B60C 11/005; B60C 1/0016; B60C 11/0008; B60C 11/0306; B60C 11/033; B60C 11/11; B60C 2011/0025; B60C 2011/0033; B60C 2200/10

(57) ABSTRACT

The present invention relates to a big enduro motorcycle tyre for mainly off-road use. By virtue of the particular “cap and base” arrangement of the tread band and to the specific mechanical properties of the compounds which constitute it, the tyre of the invention improves performance both off-road and in road driving, both on dry and wet surfaces.

### FIELD OF THE INVENTION

The present invention relates to a tyre for motorcycles, in particular for motorcycles of the big enduro type.

### Prior Art

Motorcycles of the big enduro or on/off-road type, also called big adventuring or dual purpose, are motorcycles with a large engine capacity, power and mass, designed to be ridden both on paved roads and off-road. These motorcycles generally have a cylinder capacity equal to or greater than 1000 cm³, a power equal to or greater than 100 hp, a maximum torque equal to or greater than 100 Nm and a mass equal to or greater than 180 kg.

Examples of big enduro motorcycles are the BMW GS 1250 R, the Ducati Multistrada V4, the KTM 1290 Super Adventure R and the Honda CRF1100L Africa Twin.

Motorcycles in this segment have a very broad spectrum of use, which ranges from purely road use, comparable to sport touring with tendencies also towards supersport, to off-road use even more severe than simple beaten roads, such as driving on dirt tracks, so-called taped, or routes including river beds, soft terrain, mud, sand and asperities of various kinds and difficulties.

To satisfy all these types of use, there are different tyre products on the market, each focused on a well-defined application, for example for sport driving on the road, tourist driving on the road, travel combined with dirt road, on-road driving combined with easy off-road or severe off-road combined with on-road driving.

Typically, tyres for big enduro motorcycles intended primarily for severe off-road use combined with road riding are marked M+S and are, for example, approved for reaching maximum speeds of 160 km/h (ETRTO speed index: Q). These tyres generally have a maximum radial section width of between 90 and 170 mm (for example between 90 and 120 mm for the front tyre and between 130 and 170 mm for the rear tyre) and are mounted on wheel rims having seating diameters typically between about 17 inches and about 21 inches (for example between 19 and 21 inches the front tyre and between 17 and 18 inches the rear tyre).

Tyres for mainly road use are made to maximise performance in terms of stability at high speeds, grip on dry and wet surfaces, handling, mileage, traction and braking on wet surfaces, comfort and wear regularity on asphalted road surfaces. In particular, these tyres, being often used in all weather conditions throughout the year, must allow high reliability and performance on road surfaces with reduced grip, such as for example wet road surfaces.

Tyres mainly for off-road use, even severe ones, are instead made to maximize performance in terms of grip, traction, controllability and directionality on uneven, slippery and/or poorly consistent terrain (for example sand, mud, gravel), so as to effectively transmit even high driving and braking torques to the ground. These tyres must also allow the aforementioned performance on wet surfaces.

Typically, in off-road use, the tyres are used at an inflation pressure which is generally much lower than that for road use in order to increase the deflection from contact with the ground of the tread and, consequently, the footprint area, the traction and road grip of the motorcycle.

In road use, the pressure must then be suitably restored to the reference values typically indicated by the motorcycle manufacturers.

The handling of the motor vehicle perceived by the driver depends on the ideal compromise of the inflation pressure, which balances all the variations of the physical parameters induced by the pressure on the tyre itself in the most profitable way.

In fact, a decrease in pressure entails both a decrease in static stiffness (in its components: lateral, vertical and longitudinal), therefore a greater deformation in every direction of the tyre itself in operation, and a decrease in dynamic stiffness (drift and camber stiffness and self-aligning moment), therefore a lower capacity of the tyre to generate dynamic forces in reaction to the various stresses, which on the road can be very intense due to the speed and higher camber angles.

A tyre inflated to pressures lower than the reference ones deforms more, and will inevitably work at higher thermal regimes, which can lead to premature decay of the tyre, since all the components, once a certain level of exposure to thermal stress is exceeded, deteriorate and lose their physical and mechanical features. Furthermore, the tyre is more difficult to steer and slow to change direction due to the greater compliance of the profile.

It is therefore advisable, when passing from road to off-road driving and vice versa, to adapt the pressure of the tyres, even by modifying them considerably (e.g. up to about 1.5 bar), to prolong their life and maximize performance. Typically, big enduro motorcycle tyres comprise a tread band having a tread pattern defined by a plurality of blocks separated by circumferential and transversal grooves, such blocks being arranged both in the central annular portion of the tread band and in the opposite annular shoulder portions of the same. Such tyres generally have a solid/void ratio of between about 0.40 and about 0.65.

To optimise performance, in motorcycle tyres it is typical to make the tread band in a two-layer structure.

Such two-layer structure comprises a rolling layer or portion (called cap) and an under-layer (called base) radially internal to the rolling layer, constituting the so-called “cap-and-base” structure.

Typically in motorcycle tyres, the cap and base layers extend annularly and axially with the cap overlapping the base for the entire width of the tread band, the radially outermost cap forming the entire rolling surface, and the base the radially innermost one, never reaching the rolling surface, as shown for example in EP3530487A1.

It is thus possible to use an elastomeric material capable of providing the cap with resistance to wear and to the formation of cracks while the elastomeric material of the base can be particularly aimed at adequately supporting the cap and/or being characterized by a low hysteresis, at cooperating in reducing rolling resistance. The base may be disposed between the belt structure and the rolling layer.

In some alternative embodiments, which however relate to motorcycle tyres for expressly road use (supersport sector) as shown for example in WO2019082012A1 and WO2021090152A1, the rolling surface of the tread band may comprise a central annular portion consisting of the under-layer emerging on the surface, which is flanked on both sides by one or more annular sectors of different compounds. In this application, the riding of the motorcycle is completely different from the big enduros being characterized by even very high camber angles which place the shoulder portions of the tread continuously in contact with the road surface.

JP2007125988A discloses a cap & base tyre for motorcycles in which the cap layer (32) extends axially over the entire width of a central annular portion (W2) and the base layer (34) extends axially over the entire width of the central annular portion and on each annular portion of the shoulder (W1).

The document reports neither the presence of blocks in the tread with a specific void/solid ratio nor the extension of the annular portions. The elastic modulus values E1 and E2 of the compounds of the cap layer (32) and of the base layer (34), measured at 60° C. without further indications on the test conditions, respectively assume the values of 11 kgf/mm²≤E1≤16 kgf/mm² and 7 kgf/mm²≤ E2≤13 kgf/mm² (par. 0019).

JP6053550B2 discloses a cap & base tyre for two-wheeled vehicles comprising a base layer (38), an intermediate layer (40) and a cover layer (42) laminated in the radial direction. The document does not mention the elastic modulus values of the compounds that make up these layers.

### SUMMARY OF THE INVENTION

The Applicant found itself considering a motorcycle segment, that of the “big enduro” motorcycles which, as already mentioned, has a very broad spectrum of use.

The Applicant has observed that in order to optimally cover their entire area of use, big enduro motorcycles should be equipped with tyres suitable for allowing high performance both on the road (mainly stability at high speeds, grip on dry and wet, handling) and off-road (mainly traction, controllability and directionality), together with the ability to cover many kilometres.

However, the Applicant has found that with the current and increasingly widespread tendency to exaggerate road performance on the one hand and off-road performance on the other, the aforementioned performance features are at least partially antithetical to each other. In fact, tyres that allow high performance on the road usually have performance limits in severe off-road conditions and vice versa.

The Applicant has also noted that tyres which combine on-road and off-road use with good compromise solutions do not allow satisfactory extreme performance to be achieved in either of the two fields (road and off-road). In this regard, it should be noted that recently, in accordance with customer requests, the market has moved towards more specialised solutions, envisaging several segments of tyres for big enduro motorcycles, each of these segments being focused on a particular prevalent use of the motorcycle.

Consistently, the Applicant has proposed tyres for big enduro motorcycles suitable for mainly road use and tyres for big enduro motorcycles suitable for mainly off-road use.

The Applicant has focused its attention on the segment of tyres designed for prevalent off-road use for big enduro motorcycles.

These tyres are generally chosen by users who seek performance on off-road routes and who expect use on the road limited to transfer journeys to/from off-road routes.

This type of tyre is approved for road use but is mainly intended for off-road use, even severe. In this specific application, unlike mainly road use, the motorcycle is driven in a substantially vertical position or with a limited roll angle (camber) of the order of 25°-30° and the shoulder portions of the tyre tread band hardly touch the ground.

The Applicant has thought of making a tyre which is capable of maintaining excellent off-road performance and which has road behaviour suitable for allowing the user to take even longer and more articulated road journeys in safety and comfort conditions compared to those of simple transfer to/from off-road routes, improving the behaviour thereof on dry road surfaces and above all on wet road surfaces, where grip becomes a particularly critical aspect.

The Applicant has found that in order to improve the aforementioned on-road behaviour while maintaining that off-road, it is advisable to provide a tread band formed by at least one cap and a base in which, contrary to the typical configurations discussed above, the under-layer, base, surfaces at the radially outer portion of the tread band in the lateral annular portions thereof (shoulder portions) while the radially outer central annular portion is formed by the cap layer. This arrangement of the layers together with the choice of suitable elastomeric compounds with suitable properties for the composition of the cap and base layers mean first of all that, during off-road use, the tread band of the tyre flexes much more at the shoulder portions and provides a larger footprint area, therefore better traction, controllability and comfort, even at full inflation pressure.

This greater flexibility in the shoulder portions and the consequent greater footprint area of the tread band give an advantage in off-road performance irrespective of the pressure used, in fact allowing excellent off-road driveability even at pressures comparable or only slightly lower than the road ones.

Furthermore, this tyre has unexpectedly better road performance, in terms of stability, handling and comfort, on both dry and wet road surfaces.

This result is completely innovative and goes against the general knowledge of the specific sector of big enduro tyres mainly for off-road use.

The Applicant has found that, with the present cap and base configuration, and with the choice for its realisation of compounds having properties suitable for the performance in use required precisely in the specific positions of the tread band in which they are located, it is possible to maintain or even improve off-road performance even at full inflation pressure or minimal deflation, while improving on-road performance.

The Applicant has in fact intuited that in a big enduro tyre for mainly off-road use, the tread band is typically subject, in operation, to different stresses and thermal regimes:
maximum for the central annular portion which always works in contact with the road and off-road surface;
intermediate for the shoulder portions, which in predominantly straight riding in this sector do not touch the ground but are subject, above all off-road, to continuous bending, and
minimum for the internal under-layer, which never touches the road surface nor is subject to such marked and repeated bending.

Therefore the Applicant has realised that with the present innovative cap and base configuration it is possible to both satisfy the need for very high performance of the central annular portion with a specific first cap compound having certain optimal properties (greater wear resistance, better adherence), and to comply with the different requirements of the shoulder portions (flexibility) and of the inner under-layer (thermal stability) with a second base compound having different properties with respect to the first compound, second compound which forms the under-layer and which appropriately rises to the surface only in shoulder portions. Therefore, the present invention relates to a tyre (1) for in-/off-road motorcycles (big enduro) comprising a tread band (8) of total radial thickness S including a plurality of blocks and grooves defining in the tread band (8) a void/solid ratio between 0.40 and 0.65, said tread band (8) comprising a central annular portion (A) arranged symmetrically straddling the equatorial plane (X-X) and a pair of annular shoulder portions (B) arranged symmetrically on opposite sides with respect to said central annular portion (A) and adjacent to it, wherein:
the central annular portion (A) extends axially for a width between 70% and 90%, of the width of the tread band and comprises a rolling layer (8a) of radial thickness S1 in the outermost radial position and an under-layer (8b) of radial thickness S2 adjacent to it arranged in the innermost radial position, the tread band (8) having the total radial thickness S=S1+S2,
said rolling layer (8a) extending axially across the entire width of said central annular portion (A) and said under-layer (8b) extending axially across the entire width of said central annular portion (A) and across the entire width of each annular shoulder portion (B),
each annular shoulder portion (B) extends axially for a width between 5% and 15% of the width of the tread band and is made of said under-layer (8b) for the entire total radial thickness S of the tread band,
wherein said rolling layer (8a) comprises a first elastomeric compound characterized by an E′ modulus (measured at 70° C. 10 Hz according to the method described in the experimental part) between 5.00 and 6.50 MPa, and said under-layer (8b) comprises a second elastomeric compound characterized by an E′ modulus (at 70° C. 10 Hz) between 3.50 and 4.60 MPa, and wherein the % ratio between said E′ modulus of the second compound and said E′ modulus of the first compound is between 70% and 90%.

### Definitions

The term “tyre for motorcycles” means a vulcanised tyre having a high curvature ratio (typically greater than 0.20) and capable of reaching high camber angles during cornering.

“Curvature ratio” it is meant the ratio between the distance between the radially highest point of the tread band and the maximum radial section width of the tyre (this distance being also identified as “deflection”), and the same maximum width of the tyre, in a cross section thereof.

“Camber angle” means the angle between the equatorial plane of the tyre mounted on the motorcycle wheel and a plane orthogonal to the road surface.

“Maximum radial section width”, or “maximum chord” means the maximum width of the tyre profile, i.e. the dimension of the segment having as extremes the two axially outermost points of the tread band profile.

“Equatorial plane” of the tyre means a plane perpendicular to the axis of rotation of the tyre and which divides the tyre into two symmetrically equal parts.

“Tread pattern” means the representation of all points of the tread band (including grooves) on a plane perpendicular to the equatorial plane of the tyre and tangent to the maximum diameter of the tyre. The tread pattern is defined by a plurality of blocks separated by grooves and possibly including recesses.

“Block” means a portion of the tread band delimited by grooves. If the block is positioned on the axially outermost portion of the tread band, it is delimited in the axial direction by the axially outermost face of the tread band and, in the axially innermost position, by at least one groove.

“Groove” means a groove formed on the tread band to delimit a portion of the block.

The measurements of angles, and/or linear quantities (distances, widths, lengths, amplitudes, axial and/or circumferential sections, etc.), and/or surfaces are to be understood as referring to the tread pattern as defined above.

“Width” means a dimension measured along a direction orthogonal to the equatorial plane.

“Circumferential length” means a dimension measured along a direction lying on, or parallel to, the equatorial plane.

The expression “maximum extension” referring to a block indicates the distance between the two axially or circumferentially outermost points of the block measured along a direction perpendicular to the equatorial plane or along a direction parallel to, or lying in, the equatorial plane, respectively.

The terms “radial” and “axial” and the expressions “radially internal/external” and “axially internal/external” are used referring respectively to a direction parallel to the equatorial plane of the tyre and to a direction perpendicular to the equatorial plane of the tyre, i.e. respectively to a direction perpendicular to the axis of rotation of the tyre and to a direction parallel to the axis of rotation of the tyre.

The terms “circumferential” and “circumferentially” are used with reference to the direction of the circumferential development of the tyre, i.e. to the rolling direction of the tyre, which corresponds to a direction lying on a plane coinciding with or parallel to the equatorial plane of the tyre.

“Circumferential development” of the tyre, or of the tread band or of portions thereof, means the plan development of the radially outermost surface of the tyre, or of the tread band or of portions thereof, on a plane tangential to the tyre.

The expressions “axially innermost” and “axially outermost” indicate a position closer to, and further away from, respectively, the equatorial plane with respect to a reference element.

By annular portion of tread band it is meant a tread band portion extending circumferentially for the entire tread band and of predetermined axial extension. The distance of an annular tread portion from the equatorial plane is evaluated axially by referring to the closest end plane parallel to the equatorial plane of the annular portion.

“Substantially axial direction” means a direction inclined, with respect to the equatorial plane of the tyre, by an angle of between 70° and 90°.

“Substantially circumferential direction” means a direction oriented, with respect to the equatorial plane of the tyre, at an angle of between 0° and 20°.

“Circumferential groove” means a groove comprising at least one groove portion extending along a substantially circumferential direction.

“Transverse groove” means a groove comprising at least one groove portion which extends along a substantially axial direction.

The expression “substantially parallel” indicates not only a condition of perfect parallelism, but also a condition in which one deviates from perfect parallelism with an angle not greater than 10°.

By “solid/void ratio” it is meant the ratio between the overall surface of the grooves of a given annular portion of the tyre tread pattern (possibly of the entire tread band or the tread pattern) and the surface of the given tread pattern portion (possibly of the entire tread band or tread pattern).

The “footprint area” of the tyre means the portion of the tyre in contact with the ground or road surface when the tyre is mounted on a wheel rim and a predetermined vertical load is exerted on the tyre.

The term “phr” (acronym for parts per hundreds of rubber) indicates the parts by weight of a given elastomeric compound component per 100 parts by weight of the elastomeric polymer, considered net of any plasticising extension oils.

“Elastomeric material” means a material comprising a vulcanisable natural or synthetic polymer and a reinforcing filler, wherein such material, at room temperature and after being subjected to vulcanisation, is susceptible to deformations caused by a force and is capable of quickly and vigorously recovering the substantially original shape and dimensions after the elimination of the deforming force (according to the definitions of the ASTM D1566-11 Standard Terminology Relating To Rubber).

The term “diene polymer” indicates a polymer or copolymer derived from the polymerisation of one or more different monomers, among which at least one of them is a conjugated diene (conjugated diolefin).

The term “elastomeric compound” indicates the compound obtainable by mixing and possibly heating at least one elastomeric polymer with at least one of the additives commonly used in the preparation of tyre compounds.

The term “vulcanisable elastomeric compound” indicates the elastomeric compound ready for vulcanisation, obtainable by incorporation into an elastomeric compound of all the additives, including those of vulcanisation.

The term “vulcanised elastomeric compound” means the material obtainable by vulcanisation of a vulcanisable elastomeric compound.

The term “vulcanisation” refers to the cross-linking reaction in a natural or synthetic rubber induced by a typically sulphur-based cross-linking agent.

The term “vulcanising agent” indicates a product capable of transforming natural or synthetic rubber into elastic and resistant material due to the formation of a three-dimensional network of inter- and intra-molecular bonds. Typical vulcanising agents are sulphur-based compounds such as elemental sulphur, polymeric sulphur, sulphur-donor agents such as bis [(trialkoxysilyl) propyl]polysulphides, thiurams, dithiodimorpholines and caprolactam-disulphide.

The term “vulcanisation accelerant” means a compound capable of decreasing the duration of the vulcanisation process and/or the operating temperature, such as TBBS, sulphenamides in general, thiazoles, dithiophosphates, dithiocarbamates, guanidines, as well as sulphur donors such as thiurams.

The term “vulcanisation activating agent” indicates a product capable of further facilitating the vulcanisation, making it happen in shorter times and possibly at lower temperatures. An example of activating agent is the stearic acid-zinc oxide system.

The term “vulcanisation retardant” indicates a product capable of delaying the onset of the vulcanisation reaction and/or suppressing undesired secondary reactions, for example N-(cyclohexylthio) phthalimide (CTP).

The term “vulcanisation package” is meant to indicate the vulcanising agent and one or more vulcanisation additives selected from among vulcanisation activating agents, accelerants and retardants.

The term “reinforcing filler” is meant to refer to a reinforcing material typically used in the sector to improve the mechanical properties of tyre rubbers, preferably selected from among carbon black, conventional silica, such as silica from sand precipitated with strong acids, preferably amorphous, diatomaceous earth, calcium carbonate, titanium dioxide, talc, alumina, aluminosilicates, kaolin, silicate fibres and mixtures thereof.

The term “white filler” is meant to refer to a conventional reinforcing material used in the sector selected from among conventional silica and silicates, such as sepiolite, paligorskite also known as attapulgite, montmorillonite, alloisite and the like, possibly modified by acid treatment and/or derivatised. Typically, white fillers have surface hydroxyl groups.

The expression “reinforcing cord”, or more simply “cord”, means a thread-like element consisting of one or more elongated elements (also called “yarns”) possibly covered by, or incorporated in, a matrix of elastomeric material.

### DETAILED DESCRIPTION OF THE INVENTION

In the continuation of the present description and in the following claims, even if not expressly indicated, any numerical value is understood to be preceded by the term “about” to also indicate any numerical value that deviates slightly from that described, for example to take into account the typical dimensional tolerances of the reference sector.

Furthermore, when reference is made to any range of values between a minimum and a maximum value, the aforesaid minimum and maximum values are understood to be included in the aforesaid range, unless expressly provided otherwise.

Furthermore, all ranges include any combination of the maximum and minimum values described and include any intermediate range, even if not expressly specifically described.

The tyre according to the invention is characterised by one or more of the following features taken individually or combined.

The tyre according to the invention comprises a tread band (8) of total radial thickness S.

The total radial thickness S of the tread band (8) and the radial thicknesses S1 and S2 of the rolling layer (8a) and of the under-layer (8b) refer to the tyre after shaping and vulcanisation.

Preferably, the total radial thickness S of the tread band is between 10 mm and 20 mm, more preferably between 12 mm and 16 mm, for example 14.5 mm, to allow adequate tread life and tyre integrity. Furthermore, the thickness of the tread band must be sufficient to ensure that, after vulcanisation, the grooves are not too close to the carcass plies and/or the belt structure.

The total radial thickness S of the tread band may not be constant, in particular it may vary from the central annular portion to the shoulder portions.

In one embodiment, the total radial thickness S is greater in the central annular portion (A) than in the annular shoulder portions (B). Preferably, the total radial thickness S of the central annular portion (A) is between 110% and 120% of the total radial thickness S of the annular shoulder portions B.

Preferably, the thickness S1 of the rolling layer (8a) in the central annular portion (A) is between 9 mm and 17 mm, more preferably between 11 mm and 15 mm.

The thickness S2 of the under-layer (8b) in the central annular portion (A) is not generally uniform as it is subjected, during the vulcanisation and in particular moulding step, to sliding and deformations impressed by the mould for defining the blocks and grooves.

Preferably, the thickness S2 of the under-layer (8b) in the central annular portion (A) is between 0.8 mm and 4 mm, more preferably between 1.0 mm and 3 mm, even more preferably between 1.0 mm and 2.0 mm, so as to provide adequate support.

In the annular shoulder portions (B), the thickness S2 of the under-layer (8b) instead coincides with the total radial thickness S of the tread band.

In the tyre of the invention, the sum of the widths of the axial developments of the two shoulder sectors (B) and of the axial development of the central annular sector (A) corresponds to the width of the axial development of the tread band (8).

Preferably, the central annular portion (A) extends axially for a width between 75% and 85% of the width of the tread band.

Preferably, each annular shoulder portion (B) extends axially for a width between 7.5% and 12.5% of the width of the tread band.

Preferably, the axial developments of the two annular shoulder sectors (B) have the same width.

In the tyre of the invention, said rolling layer (8a) is preferably entirely formed by said first elastomeric compound and/or said under-layer (8b) is entirely formed by said second elastomeric compound.

In the tyre of the invention, the first compound of the rolling layer of the central annular portion (A) has a dynamic elastic E′ modulus in compression (measured at 70° C., 10 Hz according to the method described in the experimental part) greater than the E′ modulus (70° C., 10 Hz) of the second compound of the annular shoulder portions (B).

Preferably, the first compound and the second compound are selected so that the finished (vulcanised) tyre has, at the annular shoulder portions (B), a vulcanised elastomeric material with a dynamic elastic E′ modulus (measured at 70° C., 10 Hz) between 75% and 90%, more preferably between 80% and 85% of the dynamic elastic E′ modulus (measured at 70° C., 10 Hz) of the vulcanised elastomeric material of the rolling surface of the central annular portion (A).

Preferably, said first elastomeric compound is characterised by an E′ modulus (measured at 70° C. 10 Hz) not greater than 6.50 MPa, more preferably not greater than 6.00 MPa.

Preferably, said first elastomeric compound is characterised by an E′ modulus (measured at 70° C. 10 Hz) between 5.00 and 6.00 MPa, more preferably between 5.00 and 5.50 MPa.

Preferably, said first elastomeric compound is characterised by an E′ modulus (measured at 70° C. 10 Hz) greater than 5.00 MPa, more preferably greater than 5.50 MPa.

Preferably, said second elastomeric compound is characterised by an E′ modulus (measured at 70° C. 10 Hz) not greater than 4.60 MPa, more preferably not greater than 4.50 MPa, even more preferably not greater than 4.40 MPa.

Preferably, said second elastomeric compound is characterised by an E′ modulus (measured at 70° C. 10 Hz) greater than 4.00 MPa, more preferably greater than 4.20 MPa.

Preferably, said second elastomeric compound is characterised by an E′ modulus (measured at 70° C. 10 Hz) between 4.00 and 4.50 MPa, more preferably between 4.20 and 4.40 MPa.

In one embodiment, said first elastomeric compound is characterised by an E′ modulus (measured at 70° C. 10 Hz) greater than 5.00 MPa, more preferably greater than 5.50 MPa, and said second elastomeric compound is characterised by an E′ modulus (measured at 70° C. 10 Hz) not greater than 4.60 MPa, more preferably not greater than 4.50 MPa, even more preferably not greater than 4.40 MPa.

Preferably, the difference between said E′ modulus of the first compound and said E′ modulus of the second compound, (measured at 70° C. 10 Hz), is between 0.3 and 2.3 MPa, more preferably between 0.4 and 1.5 MPa, even more preferably between 0.6 and 1.1 MPa.

In the tyre of the invention, the first compound of the rolling layer of the central annular portion (A) and the second compound of the under-layer of the tread band (8) are selected so that the finished (vulcanised) tyre has, at the rolling surface of the central annular portion (A), a vulcanised elastomeric material having a tan delta (measured at 70° C., 10 Hz) greater than the tan delta (measured at 70° C. 10 Hz) of the vulcanised elastomeric material of the annular shoulder portions (B). Preferably, the first compound and the second compound are selected so that the finished (vulcanised) tyre has, at the annular shoulder portions (B), a vulcanised elastomeric material with a tan delta (measured at 70° C., 10 Hz) between 45% and 65%, more preferably between 50% and 60% of the tan delta (measured at 70° C., 10 Hz) of the vulcanised elastomeric material of the rolling surface of the central annular portion (A).

Preferably, said first elastomeric compound is characterised by a tan delta (measured at 70° C. 10 Hz) greater than 0.220, more preferably greater than 0.230.

Preferably, said first elastomeric compound is characterised by a tan delta (measured at 70° C. 10 Hz) between 0.220 and 0.280, more preferably between 0.230 and 0.270.

Preferably, said second elastomeric compound is characterised by a tan delta (measured at 70° C. 10 Hz) not greater than 0.180, more preferably not greater than 0.170.

Preferably, said second elastomeric compound is characterised by a tan delta (measured at 70° C. 10 Hz) between 0.120 and 0.180, more preferably between 0.135 and 0.150.

Preferably, said first elastomeric compound is characterised by an IRHD hardness measured at 23° C. of less than 78, more preferably less than 75 and/or greater than 66, more preferably greater than 68.

Preferably, said first elastomeric compound is characterised by an IRHD hardness measured at 23° C. between 66 and 76, more preferably between 68 and 74.

Preferably said second elastomeric compound is characterised by an IRHD hardness measured at 23° C. of less than 73, more preferably less than 71 and/or greater than 63, more preferably greater than 65.

Preferably said second elastomeric compound is characterised by an IRHD hardness measured at 23° C. between 63 and 73, more preferably between 65 and 71.

In the present tyre, said first compound preferably has a load at 300% of elongation CA3 lower than the load CA3 of the second compound measured at 23° C. according to the UNI 6065:2001 standard.

Preferably, said first elastomeric compound is characterized by a load at 100% elongation CA1 between 1.7 and 2.3 MPa, more preferably between 1.9 and 2.1 MPa, and/or a load at 300% elongation CA3 between 7.7 and 10.5 MPa, more preferably between 8.6 and 9.5 MPa, measured at 23° C. according to the UNI 6065:2001 standard.

Preferably, said second elastomeric compound is characterized by a load at 100% elongation CA1 between 1.7 and 2.3 MPa, more preferably between 1.9 and 2.1 MPa, and/or a load at 300% elongation CA3 between 8.6 and 11.7 MPa, more preferably between 9.7 and 10.7 MPa, measured at 23° C. according to the UNI 6065:2001 standard.

In a preferred embodiment of the tyre of the invention, said first compound of the rolling layer of the central annular portion (A) of the tread band (8) has a load value CA3 measured at 23° C. between 7.7 and 10.5 MPa, a dynamic elastic modulus E measured at 70° C., 10 Hz between 5.00 and 6.00 MPa, a tan delta measured at 70° C., 10 Hz between 0.220 and 0.280, a dynamic elastic E′ modulus measured at 23° C., 10 Hz between 6.60 and 10.00 MPa and a tan delta measured at 23° C., 10 Hz between 0.320 and 0.431.

More preferably, said first compound has a load value CA3 measured at 23° C. between 8.6 and 9.5 MPa, a dynamic elastic E′ modulus measured at 70° C., 10 Hz between 5.00 and 5.50 MPa, a tan delta measured at 70° C., 10 Hz between 0.230 and 0.270, a dynamic elastic E′ modulus measured at 23° C., 10 Hz between 7.00 and 8.60 MPa and a tan delta measured at 23° C., 10 Hz between 0.337 and 0.412.

In the preferred embodiment of the invention, the second compound of the under-layer has a load value CA3 measured at 23° C. between 8.6 and 11.7 MPa, a tan delta measured at 70° C., 10 Hz between 0.120 and 0.180 and a dynamic elastic E′ modulus measured at 70° C., 10 Hz between 4.00 and 4.50 MPa, a dynamic elastic E′ modulus measured at 23° C. 10 Hz between 4.80 and 6.50 MPa and a tan delta measured at 23° C. 10 Hz between 0.262 and 0.354.

More preferably, the second compound has a load value CA3 measured at 23° C. between 9.7 and 10.7 MPa, a tan delta measured at 70° C., 10 Hz between 0.135 and 0.150 and a dynamic elastic E′ modulus measured at 70° C., 10 Hz between 4.20 and 4.40 MPa, a dynamic elastic E′ modulus measured at 23° C. 10 Hz between 5.10 and 6.30 MPa and a tan delta measured at 23° C. 10 Hz between 0.277 and 0.339.

In this preferred embodiment, the first compound has a hardness IRHD at 23° C. between 69 and 73 while the second compound between 65 and 69.

Typically, for the preparation of the compounds of the tyre according to the invention, the ingredients listed below and others typically used in the tyre industry sector may be used.

In particular, for the preparation of the under-layer (8b) and rolling layer (8a) compounds, elastomeric compositions may be used comprising at least one elastomeric diene polymer, selected for example from elastomeric diene polymers commonly used in sulphur-cross-linkable elastomeric compositions (vulcanisation), peroxides or other systems known to those skilled in the art and which are particularly suitable for the production of tyres, or from elastomeric polymers or copolymers with an unsaturated chain having a glass transition temperature (Tg) normally below 20° C., preferably in the range from 0° C. to −110° C.

The under-layer (8b) and rolling layer (8a) compounds comprise 100 phr of at least one diene elastomeric polymer preferably comprising at least one styrene-butadiene rubber selected from: solution-polymerised styrene-butadiene rubber (S-SBR), emulsion-polymerised styrene-butadiene rubber (E-SBR), or mixtures thereof. Styrene butadiene rubber may be present in an amount ranging for example from 20 to 90 phr.

Commercial examples of SBR polymers useful in the present invention are Tufdene E581 and E680 polymers from Ashai-Kasei (Japan), SPRINTAN SLR4602, SLR3402 and SLR4630 from Trinseo (Germany), HPR620 from JSR Corporation (Japan), BUNA SL-4518, BUNA SE 1502 and BUNA CB 22 from Arlanxeo (Germany), Europrene 5543T, Europrene 1739 and Intol 1789 from ENI (Italy), HP 755 from Japan Synthetic Rubber Co. (Japan), and NIPOL NS 522 from Zeon Co. (Japan).

The under-layer (8b) and rolling layer (8a) compounds may comprise at least one butadiene polymer (BR), preferably low cis-functionalised BR, in an amount for example from 10 to 50 phr.

The under-layer (8b) and rolling layer (8a) compounds may comprise one or more liquid polymers selected from among liquid polymers and copolymers based on alkylene, preferably based on butadiene (BR), isoprene (IR), isoprene/butadiene rubber (IBR), styrene/butadiene rubber (SBR), optionally hydroxy and epoxy functionalised, or from among depolymerized liquid natural polymers (NR), in an amount for example from 1 to 40 phr.

The under-layer (8b) and rolling layer (8a) compounds may comprise at least one resin.

The at least one resin may be a polyterpene resin selected from the homo- or copolymers of alpha-pinene, beta-pinene, limonene, and vinyl aromatic monomers (styrene) and/or aromatic monomers (phenol).

Examples of commercial terpene-based natural resins are: Piccolyte F90 and Piccolyte F105 Resin 2495, manufactured by PINOVA; Dercolyte A 115 and Dercolyte M 115, manufactured by DRT.

The at least one resin may be a hydrocarbon resin, selected for example from resins derived from coumarone-indene, styrene-indene, styrene-alkylstyrene, and aliphatic resins.

Specific examples of commercially available hydrocarbon resins are NOVARES C resins, manufactured by RUTGERS CHEMICAL GmbH (indene-coumarone synthetic resins).

Examples of commercially available styrene-indene hydrocarbon resins are UNILENE A 100, manufactured by Braskem, and Novares TT 90, manufactured by Ruetgers.

The at least one resin may be present in amounts for example from 0 to 50 phr.

The under-layer (8b) and rolling layer (8a) compounds according to the present invention may comprise at least one plasticising oil.

The term “plasticising oil” means a process oil derived from petroleum or a mineral oil or a vegetable oil or a synthetic oil or combinations thereof.

The plasticising oil may be a process oil derived from petroleum selected from paraffins (saturated hydrocarbons), naphthenes, aromatic polycyclic and mixtures thereof.

Examples of suitable process oils derived from petroleum are aromatic, paraffinic, naphthenic oils such as MES (Mild Extract Solvated), DAE (Distillate Aromatic Extract), TDAE (Treated Distillate Aromatic Extract), TRAE (Treated Residual Aromatic Extract), RAE (Residual Aromatic Extract) known in the industry.

The plasticising oil may be an oil of natural or synthetic origin derived from the esterification of glycerol with fatty acids, comprising glycerine triglycerides, diglycerides, monoglycerides or mixtures thereof.

Examples of suitable vegetable oils are sunflower, soybean, linseed, rapeseed, castor and cotton oil.

The plasticising oil may be a synthetic oil selected from among the alkyl or aryl esters of phthalic acid or phosphoric acid.

An example of oil used in compounds is Tri-(2-ethylhexyl)-phosphate (TOF) from Lanxess.

Preferably, oils of natural (for example vegetable) or synthetic origin have a glass transition temperature (Tg) lower than −70° C. (according to the ISO 28343:2010 standard).

Examples of suitable commercial plasticising oils are oils derived from petroleum: NYTEX 4700 marketed by Nynas, EXTENSOIL 1471 marketed by Repsol, VIVATEC 500 marketed by H&R; and vegetable oils: RADIA 6132 marketed by Oleon, Agripure AP 18 and Agripure AP 75 marketed by Cargill.

The overall amount of oil, which includes both the added oil and that possibly already present as a diluent of the elastomeric polymers, may be for example from 10 to 70 phr.

The under-layer (8b) and rolling layer (8a) compounds may comprise at least one reinforcing filler, in an amount for example from 10 phr to 150 phr.

The reinforcing filler may be selected from carbon black, white fillers, silicate fibres or mixtures thereof.

In an embodiment, said reinforcing filler is a white filler selected from among hydroxides, oxides and hydrated oxides, salts and hydrated salts of metals, silicates fibres or mixtures thereof. Preferably, said white filler is silica.

Commercial examples of suitable conventional silica are Zeosil 1165 MP from Solvay, and Ultrasil 7000 GR from Evonik.

In one embodiment, said reinforcing filler is carbon black.

Preferably, the carbon black is selected from those having a surface area not smaller than 20 m²/g, preferably larger than 50 m²/g (as determined by STSA-statistical thickness surface area according to ISO 18852:2005).

The carbon black may be, for example, N234, N326, N330, N375 or N550, N660 marketed by Birla Group (India) or CRX 1391 by Cabot Corporation.

The reinforcing filler may comprise mixtures, for example of carbon black and silica.

The under-layer (8b) and rolling layer (8a) compounds may comprise at least one vulcanising agent, in an amount for example from 0.5 to 7 phr.

The at least one vulcanising agent is preferably selected from sulphur, or alternatively, sulphur-containing molecules (sulphur donors), such as for example bis(trialcoxysilyl) propyl]polysulphides and mixtures thereof.

Preferably, the vulcanisation agent is sulphur, preferably selected from soluble sulphur (crystalline sulphur), insoluble sulphur (polymeric sulphur), (iii) oil-dispersed sulphur and mixtures thereof.

Commercial examples of vulcanising agent suitable for use in the elastomeric composition of the invention are Rhenocure (R) IS90P from RheinChemie or the sulphur Redball Superfine from International Sulfur Inc.

In the present elastomeric compounds, the vulcanising agent may be used together with adjuvants such as vulcanisation activators, accelerants and/or retardants known to those skilled in the art.

The under-layer (8b) and rolling layer (8a) compounds may comprise at least one vulcanisation activating agent.

The vulcanisation activating agents suitable for use in the present elastomeric compound are zinc compounds, in particular ZnO, ZnCO₃, zinc salts of saturated or unsaturated fatty acids containing from 8 to 18 carbon atoms, which are preferably formed in situ in the elastomeric compound by reaction of ZnO and of the fatty acid or mixtures thereof. For example, zinc stearate may be used, preferably formed in situ, by ZnO and fatty acid, or magnesium stearate, formed by MgO, or mixtures thereof.

The vulcanisation activating agents may be present in the elastomeric compound of the invention in an amount for example from 0.2 phr to 15 phr.

Preferred activating agents derive from the reaction of zinc oxide and stearic acid. Examples of activator are Aktiplast ST Rheinchemie and Zinc bis-neodecanoate VALIKAT Zn 1910 Umicore.

The under-layer (8b) and rolling layer (8a) compounds may comprise at least one vulcanisation accelerant.

Primary and secondary vulcanisation accelerants that are commonly used may be for example selected from dithiocarbamates, guanidines, thioureas, thiazoles, sulphenamides, sulphenimides, thiurams, amines, xanthates, or mixtures thereof. Preferably, the accelerant agent is selected from mercaptobenzothiazole (MBT), N-cyclohexyl-2-benzothiazol-sulphenamide (CBS), N-tert-butyl-2-benzothiazol-sulphenamide (TBBS), dibenzothiazole disulphide (MBTS) and mixtures thereof. Commercial examples of accelerating agents suitable for use in the present elastomeric compound are N-cyclohexyl-2-benzothiazyl-sulfenamide Vulkacit® (CBS or CZ) and N-terbutyl 2-benzothiazyl sulphenamide, Vulkacit® NZ/EGC marketed by Lanxess, Tetrabenzylthiuram disulphide (Perkacit® TBzTD), dibenzothiazole disulphide Rhenogran MBTS 80, N-tert-butyl-2-benzothiazylsulphenamide from Huatai Chemicals TBBS.

Vulcanisation accelerants may be employed in an amount of, for example, 0.05 phr to 10 phr.

The under-layer (8b) and rolling layer (8a) compounds may comprise at least one vulcanisation retardant agent.

The vulcanisation retardant agent may be selected from urea, phthalic anhydride, N-nitrosodiphenylamine N-cyclohexylthiophthalimide (CTP or PVI), and mixtures thereof.

A commercial example of a suitable retardant agent is N-cyclohexylthiophthalimide VULKALENT G of Lanxess.

The vulcanisation retardant may be present in an amount of, for example, 0.05 phr to 2 phr.

The under-layer (8b) and rolling layer (8a) compounds may comprise at least one silane coupling agent, in an amount for example from 0.5 phr to 10.0 phr.

Preferably, said coupling agent is an agent selected from those having at least one hydrolysable silane group which may be identified, for example, by the following general formula (III):

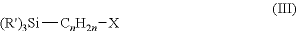

wherein the groups R′, equal or different from each other, are selected from: alkyl, alkoxy or aryloxy groups or from halogen atoms, provided that at least one of the groups R′ is an alkoxy or an aryloxy group; n is an integer of from 1 to 6; X is a group selected from: nitrose, mercapto, amino, epoxide, vinyl, imide, chloro, —(S)ₘCₙH₂ₙ—Si—(R′)₃ and —S—COR′, wherein m and n are integers of from 1 to 6 and the groups R′ are as defined above.

Preferred silane coupling agents are bis(3-triethoxysilylpropyl)tetrasulphide and bis(3-triethoxysilylpropyl)disulphide. Said coupling agents may be added as such or in mixture with an inert filler (such as carbon black) so as to facilitate their incorporation into the elastomeric compound.

An example of the silane coupling agent is TESPT: bis(3-triethoxysilylpropyl)tetrasulphide Si69 marketed by Evonik.

The under-layer (8b) and rolling layer (8a) compounds may comprise additional ingredients, commonly used in the sector, such as for example antioxidant and/or antiozonant agents (anti-ageing agents), waxes, adhesives and the like.

The under-layer (8b) and rolling layer (8a) compounds may comprise at least one wax such as a petroleum wax or a mixture of paraffins, in an amount of for example 0.1 phr to 20 phr.

Commercial examples of suitable waxes are the Repsol N-paraffin mixture and the Antilux® 654 microcrystalline wax from Rhein Chemie.

The under-layer (8b) and rolling layer (8a) compounds may comprise at least one antioxidant agent, in an overall amount for example from 0.1 phr to 20 phr.

The antioxidant agent may be selected from N-isopropyl-N′-phenyl-p-phenylenediamine (IPPD), N-(-1,3-dimethyl-butyl)-n′-phenyl-p-phenylenediamine (6PPD), N,N′-bis-(1,4-dimethyl-pentyl)-p-phenylenediamine (77PD), N,N′-bis-(1-ethyl-3-methyl-pentyl)-p-phenylenediamine (DOPD), N,N′-bis-(1,4-dimethyl-pentyl)-p-phenylenediamine, N,N′-diphenyl-p-phenylenediamine (DPPD), N,N′-ditolyl-p-phenylenediamine (DTPD), N,N′-di-beta-naphthyl-p-phenylenediamine (DNPD), N,N′-bis(1-methylheptyl)-p-phenylenediamine, N,N′-Di-sec-butyl-p-phenylenediamine (44PD), N-phenyl-N-cyclohexyl-p-phenylenediamine, N-phenyl-N′-1-methylheptyl-p-phenylenediamine and the like and mixtures thereof.

A commercial example of a suitable antioxidant agent is 6PPD of Solutia/Eastman. In a preferred embodiment, said first elastomeric compound is obtained by vulcanisation of an elastomeric composition comprising:
0 to 30 phr of at least one liquid polymer,
0 to 20 phr of at least one resin,
10 to 60 phr of at least one plasticising oil,
wherein the sum of the liquid polymer, resin, if present, and plasticising oil is 20 to 90 phr,
100 phr of a mixture of solid diene elastomeric polymers, wherein said mixture of polymers comprises:
10 to 50 phr of at least one solid polybutadiene (BR) having
a weight average molecular weight Mw between 300,000 g/mol and 600,000 g/mol, and
a cis double bonds content of at least 95%,
10 to 70 phr of at least one emulsion-polymerised solid styrene butadiene copolymer (E-SBR) having
a Tg of −60° C. to −20° C.,
a Mooney viscosity at 160° C. between 30 and 70 MU, and
a styrene content between 15% and 50%,
10 to 80 phr of at least one solution-polymerised solid styrene butadiene copolymer (S-SBR), chain-functionalised with multi-branch coupling agents, having:
a weight average molecular weight Mw greater than 500,000 g/mol, and/or
an amount of styrene comprised between 25% and 50% and an amount of vinyl comprised between 10% and 50%, and/or
a Tg between −50° C. and −20° C., and/or
a Mooney viscosity at 160° C. between 60 and 100 MU,
at least 40 phr of at least one reinforcing filler, and
at least 1.0 phr of at least one vulcanising agent.

In a preferred embodiment, said second elastomeric compound is obtained by vulcanisation of an elastomeric composition comprising:
0 to 20 phr of at least one liquid polymer,
5 to 40 phr of at least one resin,
10 to 60 phr of at least one plasticising oil,
wherein the sum of the liquid polymer, resin, if present, and plasticizing oil is 15 to 120 phr,
100 phr of a mixture of solid diene elastomeric polymers, wherein said mixture of polymers comprises:
10 to 40 phr of at least one solid polybutadiene (BR), preferably having a weight average molecular weight Mw between 200,000 g/mol and 600,000 g/mol and a cis double bonds content of at least 30%.
60 to 90 phr of at least one end-functionalized solution-polymerised solid styrene butadiene copolymer (S-SBR), produced in continuous, preferably having a weight average molecular weight Mw greater than 500,000 g/mol, preferably greater than 800,000 g/mol, more preferably greater than 900,000 g/mol, an amount of styrene between 25% to 50% and an amount of vinyl between 10% and 70%, preferably between 10% and 50%, a Tg between −50° C. and −10° C., and/or a Mooney viscosity at 100° C. between 50 and 100 MU,
at least 50 phr of at least one reinforcing filler, and
at least 1.0 phr of at least one vulcanising agent.

### BRIEF DESCRIPTION OF THE FIGURES

FIG. 1 is a schematic view of a radial section of a rear tyre for a motorcycle according to the present invention, where for simplicity of illustration the tread band is shown without grooves and blocks, in which the arrangement of the cap (8a) and base (8b) layers is highlighted.

FIG. 2 is a perspective view of a typical big enduro knobby rear tyre, according to the present invention, where the central annular portion (A) and the annular shoulder portions (B) may be seen in dotted lines.

### DESCRIPTION OF A TYRE ACCORDING TO THE INVENTION

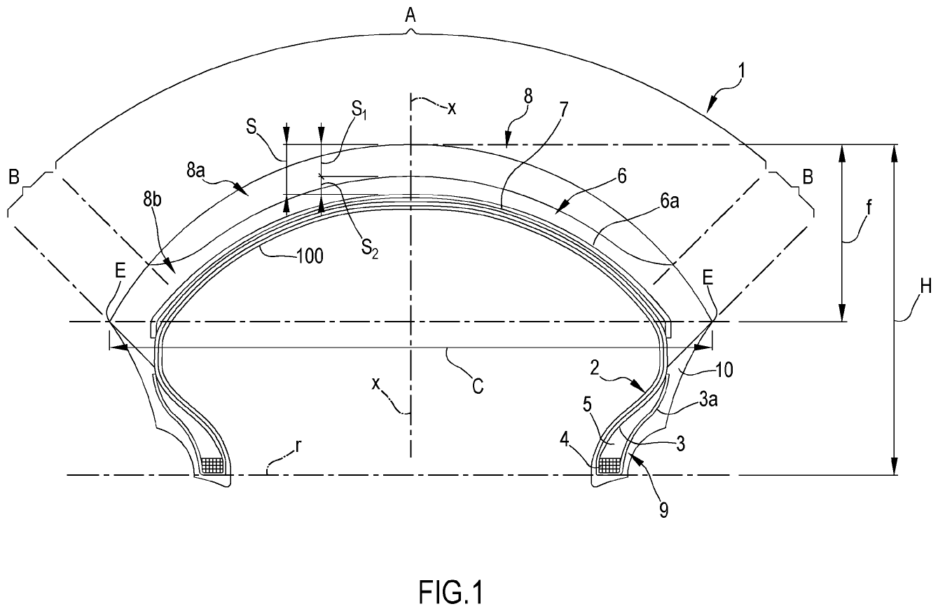

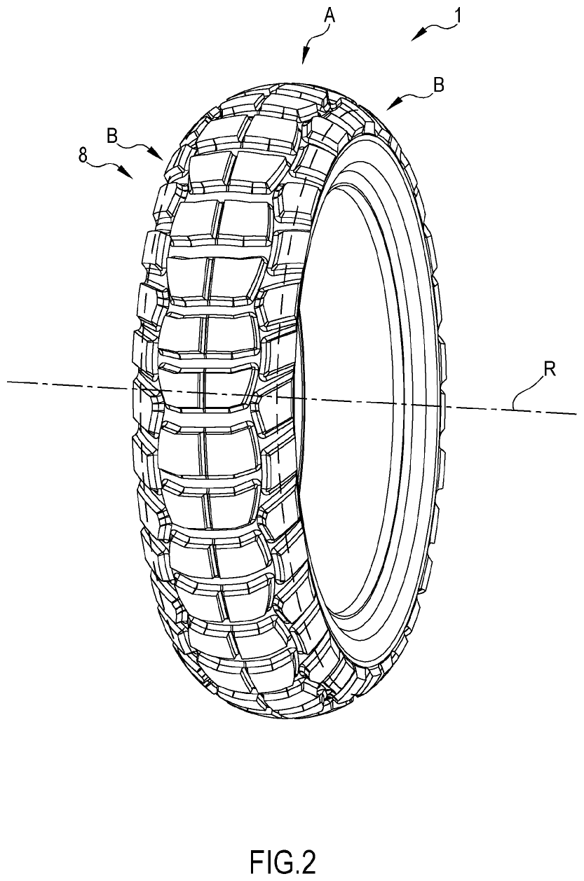

With reference to FIGS. 1 and 2, reference numeral 1 indicates a motorcycle tyre according to the present invention.

Tyre 1 is a rear tyre, but the following description applies identically to a front tyre, except when specific reference is made to rear tyres.

The tyre 1 is a motorcycle tyre defined as a big enduro with a large engine capacity (e.g. equal to 1000 cm³) and high power (e.g. equal to 100 hp) and a motorcycle mass in riding position equal to, for example, 200 kg or more.

The tyre 1 generally has a maximum radial section width of between 90 and 170 mm (for example between 90 and 120 mm in the case of front tyres and between 130 and 170 mm in the case of rear tyres) and is intended to be mounted on wheels having seating diameters between about 17 inches and about 21 inches (for example between 19 and 21 inches in the case of a front tyre and between 17 and 18 inches in the case of a rear tyre).

In tyre 1, an equatorial plane “X-X” (FIG. 1) and a rotation axis R (FIG. 2) are defined. Also defined are a circumferential direction arranged according to the direction of rotation of the tyre 1 and therefore parallel to the equatorial plane X-X and an axial direction r perpendicular to the equatorial plane “X-X” and/or parallel to the rotation axis R.

The tyre 1 comprises a carcass structure 2 formed by at least one carcass ply 3 consisting of a sheet of elastomeric material incorporating a plurality of reinforcing cords made of fibrous textile material, not shown.

In the tyre of FIG. 1, the carcass structure 2 is of the radial type, i.e. the reinforcing cords of said at least one carcass layer 3 are arranged substantially parallel to each other and in a radial direction, i.e. according to an angle between 70° and 110°, more preferably between 80° and 100°, with respect to the circumferential direction.

In an embodiment not shown, the carcass structure comprises at least two radially superimposed carcass plies. In this case, the reinforcing cords are essentially parallel to each other in each carcass ply and are oriented in inclined directions (for example at least) 45° with respect to the equatorial plane of the tyre in each carcass ply and according to opposite directions with respect to the cords of the radially adjacent carcass ply 3 (cross-ply carcass).

The carcass structure 2 is typically coated, on its internal walls, with a sealing layer 100, or so-called liner, essentially consisting of a layer of air-impermeable elastomeric material, adapted to guarantee the hermetic seal of the tyre 1 itself once inflated.

The (or each) carcass ply 3 is shaped according to a substantially toroidal configuration and has its axially opposite lateral edges 3a turned towards respective annular reinforcing structures 4 intended to hold the tyre 1 on a corresponding mounting rim (not shown). The annular reinforcing structures 4 are typically referred to as bead cores.

A tapered elastomeric filler 5 is applied to the outer peripheral edge of the bead cores 4 which occupies the space defined between the respective carcass ply 3 and the corresponding turned-up lateral edge 3a of the carcass ply 3.

In a further alternative embodiment, not shown, each carcass ply has its opposite lateral edges associated without flap with particular annular reinforcing structures provided with two annular metal inserts.

The region of the tyre 1 comprising the bead core 4 and the elastomeric filler 5 forms the so-called bead 9, which is intended for anchoring the tyre 1 to the rim, not shown.

Preferably, in a radially external position to the carcass (whether radial or with crossed plies), a carcass reinforcing structure may advantageously be provided. This reinforcing structure comprises a crown ply disposed radially outermost to the radially outer carcass ply at least for a crown portion. The crown ply is made with the reinforcing elements arranged parallel to each other and is disposed so that the reinforcing elements have an angle opposite to the equatorial plane to those of the radially outermost carcass ply. Optionally, the carcass reinforcing structure comprises two plies arranged laterally to the crown ply, axially opposite to the equatorial plane and not associated with the respective beads.

In one embodiment thereof, the (or each) carcass ply 3 is made by bringing together a plurality of strips of elastomeric material reinforced by the aforementioned cords.

A belt structure 6 is applied circumferentially, in a radially outer position, to the carcass structure 2 comprising at least one belt layer 6a typically formed of rubberised textile or metal cords.

Preferably, the belt structure 6 is of the zero degree type, i.e. the belt layer 6a is made by means of cords arranged substantially parallel and side by side to form a plurality of turns. Such turns are substantially oriented according to the circumferential direction (typically with an angle of between 0° and) 5°, such direction being usually called “zero degrees” with reference to the laying thereof with respect to the circumferential direction of the tyre 1.

Preferably, the belt layer 6a typically known as “zero degree” may comprise axially side-by-side windings of a single cord or a band of rubberised fabric comprising axially side-by-side cords.

The cords of the zero degree belt layer 6a are typically metal cords, made from high carbon steel wires, i.e. steel wires with a carbon content of at least 0.6-0.7%. Preferably, these metal cords are high elongation (HE).

In order to improve the adhesion between the belt structure 6 and the carcass structure 2, an adhesion layer 7 of elastomeric material may be provided interposed between the two aforementioned structures.

In a different embodiment, the belt structure 6 has two or more radially superimposed belt layers, each layer consisting of elastomeric material reinforced with cords arranged parallel to each other. The layers are arranged in such a way that the cords of a first belt layer are oriented obliquely with respect to the equatorial plane of the tyre, while the cords of the radially adjacent belt layer also have an oblique but crossed orientation with respect to the cords of the first layer (the so-called cross belt) and the same goes for any other belt layers. The cross belt typically involves textile cords.

A tread band (8) is circumferentially superimposed on the belt structure 6 on which, following a moulding operation performed concurrently with a vulcanisation step of the tyre 1, circumferential and transversal grooves are typically obtained, arranged to delimit a plurality of blocks according to geometries detailed in the remainder of the present description.

According to a preferred embodiment, the tread band (8) (as well as other components of the tyre) is made using the elastomeric materials as defined above.

The tread band (8) comprises a central annular portion (A) arranged symmetrically straddling the equatorial plane (X-X) and a pair of annular shoulder portions (B) arranged symmetrically on opposite sides with respect to said central annular portion (A) and adjacent to it.

The central annular portion (A) extends for a width comprised between 70% and 90%, preferably between 75% and 85% of the width of the tread band.

The tread band (8) is of the cap and base type and overall has a total radial thickness S which may vary between the centre and the shoulder and comprises a rolling layer (8a) (cap) with radial thickness S1 in the radially outermost position and an under-layer (8b) (base) of radial thickness S2 adjacent to it arranged in a radially innermost position. The tread band (8) has the total radial thickness S=S1+S2.

The rolling layer (8a) extends axially across the entire width of the central annular portion (A) and the under-layer (8b) extends axially across the entire width of the tread band or across the entire width of said central annular portion (A) and across the entire width of each annular shoulder portion (B).

Each annular shoulder portion (B) extends axially for a width between 5% and 15%, preferably between 7.5% and 12.5% of the width of the tread band and is made of said under-layer (8b) for the entire total radial thickness S of the tread band.

The following Table 1 provides some examples of the possible measurements of the cap and base extensions for some types of tyres according to the present invention:

TABLE 1

| | Tyre size | | | |
|---|---|---|---|---|
| | 170/ | 150/ | 140/ | 130/ |
| | 60R17 | 70R18 | 80R17 | 80R17 |
| Tread band width (mm) | 197.66 | 185.2 | 172.6 | 164.6 |
| Tread band half width (mm) | 98.8 | 92.6 | 86.3 | 82.3 |
| Start of annular shoulder portion | 77.5 | 73.5 | 69.7 | 67.3 |
| (B) (mm) | | | | |
| Annular shoulder portion B/tread | 22% | 21% | 19% | 18% |
| band width ratio (%) | | | | |
| Central annular portion compound | 14.5 | 14.5 | 14.5 | 14.5 |
| thickness (A) (mm) | | | | |
| Annular shoulder portion | 12.7 | 12.7 | 12.7 | 12.7 |
| compound thickness (B) (mm) | | | | |
| Under-layer S2 thickness (mm) | 1-2 | 1-2 | 1-2 | 1-2 |

The tyre 1 may also comprise a pair of sidewalls 10 applied laterally on opposite sides to said carcass structure 2.

With reference to FIG. 1, the tyre 1 has a section height “H” measured, on the equatorial plane “X-X”, between the top of the tread band (8) and the seating diameter, identified by a reference line “r” passing through the beads 9 of the tyre 1.

The tyre 1 also has a maximum radial section width “C”, defined by the distance between the laterally opposite ends “E” of the tread band 8, and a deflection “f”, defined by the distance of the top of the tread band (8) from a line passing through said laterally opposite ends “E”, measured on the equatorial plane “X-X” of the tyre 1. The laterally opposite ends “E” of the tread band (8) may be formed with a corner.

The tyre 1 has a “camber ratio” (f/C) defined by the ratio between the deflection “f” and the above maximum radial section width “C”.

The tyre 1 has a ratio of “deflection height over total” (f/H) given by the ratio between the deflection “f” and the section height “H”.

The cited references (“H”, “XX”, “r”, “C”, “f”, “E”) have been indicated in FIG. 1 for the rear tyre, but they are also identical for a front tyre.

Preferably, the deflection “f” of the tyre 1 is between about 40 mm and about 60 mm.

The tyre 1 has a camber ratio “f/C” of between about 0.25 and about 0.35, for example equal to about 0.26.

The tyre 1 has a ratio of deflection height on the total “f/H” of between about 0.40 and about 0.60, for example equal to about 0.43.

In the case of front tyres, the deflection “f” is between about 35 mm and about 60 mm and the camber ratio “f/C” is between about 0.30 and about 0.40, for example equal to 0.38.

Still in the case of front tyres, the ratio of deflection height on the total “f/H” is between about 0.40 and about 0.60, for example equal to about 0.53.

As shown in FIG. 2, the tyre 1 according to the invention is of the knobbed type, i.e. it comprises a plurality of transversal and circumferential grooves which delimit a plurality of mutually spaced blocks.

The blocks and grooves define a tread pattern with a void/full ratio between 0.40 and 0.65, preferably between 0.50 and 0.60, for example equal to 0.51 in the case of rear tyres measuring 170/60/R17 and equal to 0.56 in the case of rear tyres measuring 150/70/R18.

### Experimental Part

### Evaluation Methods

The static mechanical properties (CA1 load at 100% elongation, CA3 load at 300% of elongation) according to the UNI 6065:2001 standard were measured at 23° C. on samples of elastomeric materials, vulcanised at 170° C. for 10 minutes.

The dynamic mechanical properties E′, E″ and Tan delta were measured using an Instron model 1341 dynamic device in the tension-compression mode as described herein. A test piece of cross-linked material (170° C. for 10 minutes) having a cylindrical shape (length=25 mm; diameter=14 mm), preloaded in compression up to a longitudinal strain of 25% with respect to the initial length and maintained at the predetermined temperature of 23° C. or 70° C. for the whole duration of the test was subjected to a dynamic sinusoidal strain having an amplitude of ±3.5% with respect to the length under pre-load, with a frequency of 10 Hz or 100 Hz. The dynamic mechanical properties are expressed in terms of dynamic elastic modulus (E′), dynamic viscous modulus (E″) and Tan delta (loss factor). The Tan delta value was calculated as the ratio between the viscous dynamic modulus (E″) and the dynamic elastic modulus (E′). The hardness in IRHD degrees (23° C.) was measured according to the ISO 48:2007 standard on samples of the elastomeric materials mentioned above, vulcanised at 170° C. for 10 minutes.

### Preparation of the Compounds

Base compounds MB1 (INV), MB2 (REF) and cap compounds MC1 (INV) and MC2 (REF) were prepared starting from the compositions detailed in the following Table 2:

TABLE 2
composition of the compounds (phr)

| | | MB1 | MB2 | MC1 | MC2 |
|---|---|---|---|---|---|
| Ingredient | Producer | INV | REF | INV | REF |
| NR | Thaiteck | | | | 30 |
| | Rubber | | | | |
| TUFDENE | Asahi Kasei | 78 | | | |
| E680* | | (107.3*) | | | |
| SBR 1739* | Dow | | 44 | 44 | 55 |
| | Polymers | | (60.5*) | (60.5*) | (76*) |
| YB03 | Asahi Kasei | 22 | | | |
| SBR 1723* | ENI | | 16 | | 15 |
| | | | (22*) | | (21*) |
| HPR620* | JSR | | | 26 | |
| | | | | (32.5*) | |
| BR | ENI | | 40 | 30 | |
| N234 | Birla | | 100 | 80 | 71 |
| CRX 1391 | Cabot | 15 | | | |
| PERKASIL 408 | Grace | | | | 5 |
| ZEOSIL 1165 | Solvay | 85 | | 20 | |
| MP | | | | | |
| ULTRASIL 7000 | Evonik | | | | 20 |
| RICON 100 | Cray Valley | 4 | | 6 | |
| TDAE | Orgkhim | | 18 | 9 | 10 |
| POLYVEST 130 | Evonik | | | 9.5 | |
| TOF | Lanxess | 14 | | | |
| RESIN 2495 | DRT | 18.5 | | | |
| RASINA | Lanxess | | 4 | | |
| CUMARON | | | | | |
| RHENOSIN TT | Novares | | | | 8 |
| 90 | | | | | |
| NOVARES TT | Novares | | 6.5 | | |
| 30 | | | | | |
| Alpha-methyl | Eastman | | | 5 | |
| styrenic resin | | | | | |
| Neodecanoate | Rhein Chemie | 5.6 | | | |
| zinc 50 | | | | | |
| Stearic acid | Undesa | | 2 | 2 | 2 |
| RHENOGRAN | Zincol Ossidi | | 4 | 4 | 5 |
| ZNO | | | | | |
| ACID GRAS | Eigemann & | 2.5 | 3 | 3 | |
| SARE DE ZINC | Veronelli | | | | |
| Liquid silane | Evonik | 7.2 | | | 5 |
| Wax | Repsol | 1 | 2 | 2 | 2.5 |
| 6PPD | Eastman | 3 | 2 | 2 | 2 |
| Sulphur | Rhein Chemie | 2.1 | 2.1 | 2.1 | 2 |
| TBBS | Huatai | 2.5 | 2.3 | 2.3 | 3 |
| MBTS 80 | Rhein Chemie | 1 | | | |
| DURALINK HTS | Eastman | | | | 1.5 |
| TBZTD | Akrochem | 0.3 | | | 0.25 |

where * extended oil (total polymer + oil phr*)

NR is natural rubber (Standard Thai Rubber STR 20-Thaiteck Rubber);
TUFDENE E680 (S-SBR) is a solution-polymerised styrene-butadiene polymer-extended with 37.5 parts of TDAE oil per 100 parts of dry polymer (107.3 phr of Tufdene E680 contains 78 phr of dry polymer);
SBR 1739 is Buna® SB 1739-Schkopau, E-SBR produced by cold emulsion-polymerisation using mixed rosin/fatty acid soaps. It is plasticised with 37.5 parts of a TDAE oil in relation to solid rubber (60.5 and 76 phr of Buna® SB 1739 contain 44 and 55.3 phr of dry polymer, respectively);
YB03 Asaprene is a low cis functionalised polybutadiene polymer;
SBR 1723 is a styrene-butadiene polymer in emulsion obtained by cold polymerisation using a mixture of rosin acid and fatty acid soaps as emulsifiers, Tg around−50° C., extended with 37.5 parts TDAE oil;
HPR620 is a styrene butadiene copolymer, prepared in solution as described in SG10201800553S (A) with a continuous process, functionalised in the chain by means of a polyorganosiloxane multi-branch coupling agent, having a weight average molecular weight around 1,000,000 g/mol, styrene content of around 40%, around 25% vinyl, Tg around−33° C. and Mooney viscosity around 80 MU (Mooney viscosity ML (3+4) at 160° C.), extended with 25 parts of a TDAE oil in relation to solid rubber (32.5 phr of HPR620 contains 26 phr of dry polymer);
BR is Europrene@ Neocis BR 60, a polybutadiene with a high cis content (min. 97%) produced in solution with a neodymium organometallic catalyst;
N234 is high surface area carbon black (STSA 112 m²/g);
CRX 1391 is high surface area carbon black (STSA 156 m²/g);
PERKASIL 408 is PERKASIL® KS 408 precipitated silica with a high surface area (BET 175 m²/g);
ZEOSIL 1165 MP is silica in microbeads with a high specific surface area BET 165 m²/g;
ULTRASIL 7000 is precipitated silica with a high surface area (BET 175 m²/g)
RICON 100 is a low molecular weight (Mn 4500) liquid (25% styrene) butadiene styrene copolymer (PBS), Tg−57° C.;
TDAE is an aromatic oil plasticiser Treated Distillate Aromatic Extract, Vivatec® 500 (plasticiser);
POLYVEST 130 is a stereospecific, low viscosity and unsaponifiable liquid polybutadiene with a high content of 1,4-cis double bonds (77% 1,4-cis double bonds, 22% 1,4-transl double bonds, 1% double bonds 1,2-vinyls), Tg−99° C., weight average molecular weight 12,000 g/mol;
TOF is a plasticiser: Tri-(2-ethylhexyl)-phosphate;
RESIN 2495 is a terpenic resin;
RASINA CUMARON is a coumarone resin;
RHENOSIN TT 90 is a tackifying and dispersing hydrocarbon resin;
NOVARES TT 30 is a hydrocarbon resin produced by polymerisation of C9/C10
unsaturated aromatic hydrocarbons;
Alpha-methyl styrene resin is a thermoplastic resin;
Zinc neodecanoate 50 is the zinc salt of neodecanoic acid;
RHENOGRAN ZNO is a zinc oxide;
ACID GRAS SARE DE ZINC is a zinc salt of fatty acid;
Liquid silane is SI 69-Bis [3-(triethoxysilyl) propyl]polysulphide;
Wax is BMO1 a mixture of N-paraffins and Iso-paraffins;
6PPD is N-(1,3-dimethylbutyl)-N′-phenyl-p-phenylenediamine, an antiozonant Sulphur is Rhenocure® IS 90-20 from Lanxess, a mixture of insoluble/soluble sulphur in a 90:10 ratio plus 20% oil;
TBBS is N-tert-.utyl-2-benzothiazyl sulphenamide;
MBTS 80 is dibenzothiazyl disulphide;
DURALINK TS is hexamethylene-1,6-bis(thiosulphate) disodium salt;
TBZTD is (Perkacit® TBzTD) tetrabenzylthiourame disulphide.

The elastomeric compounds were prepared according to the following process.

The mixing of the components was carried out in two steps using an internal mixer (Banbury, Intermix or Brabender).

In the first step (1), all the ingredients were introduced with the exception of vulcanisers and accelerants. The mixing was continued for a maximum time of 5 minutes, reaching a temperature of approximately 145° C. Subsequently, in the second step (2), again carried out using an internal mixer, the vulcanisers and accelerants were added, and the mixing was continued for about 4 minutes while maintaining the temperature below 100° C. The compounds were then unloaded. After cooling and at least 12 hours from preparation, some samples of the compounds were vulcanised in a press at 170° C. for 10 min to give the specimens useful for mechanical characterisations.

### Properties of the Compounds

The main static and dynamic properties and the hardness of the aforementioned elastomeric compounds, measured by the methods described above, are shown in the following Table 3:

TABLE 3

| | | | | MB1 | MC1 | MB2 | MC2 | MB1/MC1 % | MB2/MC2 % |
|---|---|---|---|---|---|---|---|---|---|
| | | | | INV | INV | REF | REF | INV | REF |
| IRHD | | | 23° C. | 68 | 71 | 79 | 79 | 96 | 100 |
| CA1 | | | 23° C. | 1.99 | 2.02 | 2.50 | 3.90 | 99 | 64 |
| CA3 | | | 23° C. | 10.17 | 9.11 | 10.50 | 15.50 | 112 | 68 |
| E′ | 10 | Hz | 23° C. | 5.66 | 7.79 | 10.13 | 11.25 | 73 | 90 |
| Tan D | | | | 0.308 | 0.375 | 0.379 | 0.380 | 82 | 100 |
| E′ | 100 | Hz | | 7.77 | 10.16 | 12.91 | 14.77 | 76 | 87 |
| Tan D | | | | 0.501 | 0.440 | 0.437 | 0.466 | 114 | 94 |
| E′ | 10 | Hz | 70° C. | 4.30 | 5.20 | 6.71 | 6.79 | 83 | 99 |
| Tan D | | | | 0.144 | 0.256 | 0.267 | 0.231 | 56 | 115 |
| E′ | 100 | Hz | | 4.90 | 6.13 | 7.79 | 7.83 | 80 | 99 |
| Tan D | | | | 0.201 | 0.286 | 0.308 | 0.276 | 70 | 112 |

Key: base compound MB (second compound), cap compound MC (first compound); INV: invention; REF: reference

The compounds used to make the tyre according to the invention were MB1 and MC1, wherein MC1 constituted the radially outer central annular portion (A) of the tread band while MB1 constituted the radially inner under-layer rising to the surface in the annular shoulder portions (B) (see the comparative tests below). From Table 3 it may be seen that the compounds MB1 and MC1 suitable for making the tyre of the invention had rather different properties compared to the previous compounds of the under-layer MB2 and the rolling layer MC2 used in a conventional cap and base tread band (see below tyre REF1).

In particular, it could be observed that the base compound MB1 and the cap compound MC1 had significantly lower IRHD hardness and E′ modulus values compared to the compounds MB2 and MC2 respectively under all tested conditions.

The Applicant understood that the tread band of the present tyre, despite the simultaneous presence of different compounds, behaved in use in a rather homogeneous way almost as if it were formed from a single material having in the various portions of the tread modulus and hysteresis comparable to each other in the operating conditions.

This phenomenon was highlighted by the modulus and hysteresis measurements of the different compounds made at the actual conditions under which they operated in the specific portions of the tread band in which they were located, as evidenced by the values of E′ and tan delta at the various regimes shown in the present Table 3.

In this regard, the dynamic mechanical properties of the present compounds were evaluated at different levels of dynamic stress (sample stress at a frequency of 10 and 100 Hz) and at different temperatures (23° C. and 70° C.) to reproduce the conditions at which they were subjected in road and off-road driving.

In particular, considering road driving, it was possible to identify the following possible thermal regimes in operation and the relative measurement conditions of the modules, as schematised in the following Table 4:

TABLE 4
road driving

| | INV* | Thermal | E′ measurement | | |
|---|---|---|---|---|---|
| | tyre | regime | conditions | | |
| Base | MB1 | Cold | 10 | Hz | 23° C. |
| (under-layer 8b in the annular | | | | | |
| portion A) | | | | | |
| Shoulder (under-layer 8b in | MB1 | Hot | 100 | Hz | 23° C. |
| portion B) | | | | | |
| Core (A) (rolling layer 8a) | MC1 | Average | 10 | Hz | 23° C. |

*See below for the configuration of the tyre according to the invention

As may be seen from Table 3, under these conditions (i.e. 100 Hz 23° C. for the shoulder and 10 Hz 23° C. for the core), the shoulder compound (MB1) and the core compound (MC1) had practically identical E′ moduli (7.77 vs 7.79).

Instead, considering off-road driving, it was possible to identify the following possible thermal regimes in operation and the relative measurement conditions of the modules, as schematised in the following Table 5:

TABLE 5
off-road driving

| | INV* | Thermal | E′ measurement | | |
|---|---|---|---|---|---|
| | tyre | regime | conditions | | |
| Base (under-layer 8b in the | MB1 | Cold | 10 | Hz | 23° C. |
| annular portion A) | | | | | |
| Shoulder (under-layer 8b in | MB1 | Hot | 100 | Hz | 70° C. |
| portion B) | | | | | |
| Core (A) (rolling layer 8a) | MC1 | Hot | 10 | Hz | 70° C. |

In off-road driving, the central annular portion was at a high temperature but the stress was macro (blocks in engagement) and not micro (sliding), therefore the measurement frequency was 10 Hz.

As may be seen from Table 3, under these conditions (i.e. 100 Hz 70° C. for the shoulder and 10 Hz 70° C. for the core), the shoulder compound (MB1) and the core compound (MC1) had very close E′ moduli (4.90 vs 5.20).

### Comparative Tests

The Applicant has produced an example of a rear tyre 1 measuring 170/60 R17 according to an embodiment of the present invention and in particular having the cap and base arrangement illustrated in FIG. 1 and having the tread pattern illustrated in FIG. 2.

The cap layer was made with the MC1 compound while the base layer with the MB1 compound. This tyre is indicated hereinafter with INV.

Two reference rear tyres were also produced, called REF1 and REF 2 in which:
in REF1 the cap and base layers extended annularly and axially over the entire width of the tread band and consisted respectively of MC2 and MB2;
in REF2 the cap and base layers were arranged according to the invention and consisted respectively of MC2 and MB1.

Outdoor tests were carried out to compare the tyre of the invention with tyres REF1 and REF2.

The REF1 tyre was a big enduro tyre produced by the Applicant and appreciated by customers for its excellent off-road behaviour and for its behaviour on dry and wet road surfaces that was considered more than acceptable.

The REF2 tyre was a prototype made for comparative purposes to evaluate the influence of the properties of the cap and base compounds on the performance of the tyre with the same tread structure (cap and base arranged according to the invention).

The relevant measurements of the tread band and its components of the tyre of the invention INV and of the comparison tyres REF1 and REF2 are shown in the following Table 6:

TABLE 6

| tyre 170/60R17 | REF 1 | REF 2 | INV |
|---|---|---|---|
| Tread band width (mm) | 197.66 | 197.66 | 197.66 |
| Tread band half width (mm) | 98.8 | 98.8 | 98.8 |
| Start of annular lateral portion (B) (mm) | — | 77.5 | 77.5 |
| Annular shoulder portion B/tread band width | — | 22% | 22% |
| ratio (%) | | | |
| Central annular portion thickness S (A) (mm) | 14.5 | 14.5 | 14.5 |
| Annular shoulder portion thickness S (B) | 12.7 | 12.7 | 12.7 |
| (mm) | | | |
| Under-layer S2 thickness (mm) | 1-2 | 1-2 | 1-2 |

The tests were carried out by mounting the tyres (inflated with the same inflation pressure) on the rear wheel of a BMW GS 1250 R motorcycle, with the same tyre mounted on the front wheel and in substantially identical environmental conditions. The front tyres had a size of 120/70R19, with a 3.00×19 rim and inflation pressure of 2.0 bar for the off-road tests and 2.5 bar for the road tests. The rear tyres had a size of 170/60R17, with a 4.50×17 rim and inflation pressure of 2.0 bar for the off-road tests and 2.9 bar for the road tests.

The behaviour of the INV, REF1 and REF2 tyres was evaluated both on the road (dry and wet) and off-road, asking the driver for an opinion. In particular, the items listed in Tables 7, 8 and 9 below were evaluated, where the opinion expressed by the driver is also shown. The road tests were carried out along a route with straight sections and curves, both on dry and wet roads. The off-road tests were carried out by covering several times a straight stretch of a pre-set length prepared with muddy and sandy ground which replicated possible conditions found in a natural environment, keeping the ground as homogeneous as possible after each test. On the straight, 2 sensors were installed to determine when the motorcycle enters and exits and the latter was equipped with suitable instruments (GPS sensor, engine throttle valve opening sensor and speed sensors on both wheels).

Table 7 relates to tests on dry roads. Table 8 relates to the wet road tests. Table 9 relates to off-road tests.

In Tables 7-9, “=” indicates a rating comparable to that obtained with the REF1 tyre, “+” and “−” indicate an improvement or worsening compared to the REF1 tyre.

TABLE 7
tests on dry road

| | |
|---|---|
| REF1 | INV |

Straight-line driving stability

| | | |
|---|---|---|
| STABILITY in acceleration | = | = |
| STABILITY at high speed (160-170 Km/h) | = | = |

Comfort relative to contact with the road

| | | |
|---|---|---|
| ABSORPTION | = | + |

Ease of handling

| | | |
|---|---|---|
| READINESS | = | + |
| GENERAL DRIVING WEIGHT | = | + |
| SUPPORT DURING THE DESCENT IN BENDING | = | + |

TABLE 8
tests on wet road

| | | |
|---|---|---|
| REF1 | REF2 | INV |

Grip

| | | | |
|---|---|---|---|
| REAR BRAKING | = | − | + |
| REAR-WHEEL DRIVE | = | − | = |
| CONTROLLABILITY LOSS OF GRIP | = | − | + |
| FEELING OF COLD CONTACT | = | − | +++ |
| FEELING OF SECURITY | = | − | + |

Ease of handling

| | | | |
|---|---|---|---|
| LIGHTNESS OF DRIVING | = | − | = |
| TRAJECTORY MAINTENANCE | = | − | = |
| SUPPORT DURING THE DESCENT IN | = | − | = |
| BENDING | | | |

TABLE 9
off-road tests

| | |
|---|---|
| REF1 | INV |

General driving

| | | |
|---|---|---|
| GENERAL OFF-ROAD DRIVING | = | +++ |
| FRONT/REAR AXLE AGREEMENT | = | ++ |
| STRAIGHT POST ACCELERATION TRACTION | = | + |
| CONTROLLABILITY LOSS OF GRIP | = | ++ |

Absorption

| | | |
|---|---|---|
| ABSORPTION AFTER IMPACT WITH | = | + |
| OBSTACLE | | |
| REAR SUPPORT | = | + |
| COMFORT | = | ++ |

Tables 7 and 8 show how the INV tyre has unexpectedly generally offered improved performance on road surfaces compared to that of the REF1 tyre, in particular with reference to comfort and handling relating to contact with dry road surfaces and wet road grip, with a behaviour in line with that of the REF1 tyre as regards the other items evaluated. On the other hand the REF2 tyre, in which the cap compound MC2 did not have the features of the cap compound MC1 of the invention, proved to be pejorative.

The Applicant has thus verified that the use of specific compounds combined in the specific arrangement adopted in the tyre of the invention actually allowed a surprising improvement to be obtained in performance on both dry and wet road surfaces.

Table 9 instead highlighted an unexpected improvement also in off-road performance, in all the items tested. This improvement was not foreseeable and went well beyond the expectations of the Applicant which had set itself the objective of maintaining the excellent off-road behaviour of the reference tyres (REF1).

1-13. (canceled)

14. A tyre for in-/off-road motorcycles (big enduro) comprising a tread band of total radial thickness S including a plurality of blocks and grooves defining in the tread band a void/solid ratio ranging from 0.40 to 0.65,
wherein the tread band comprising a central annular portion (A) arranged symmetrically straddling the equatorial plane (X-X) and a pair of annular shoulder portions (B) arranged symmetrically on opposite sides with respect to the central annular portion (A) and adjacent to it, wherein:
the central annular portion (A) extends axially for a width rang from 70% to 90%, of the width of the tread band and comprises a rolling layer of radial thickness S1 in the outermost radial position and an under-layer of radial thickness S2 adjacent to it arranged in the innermost radial position, the tread band having the total radial thickness S=S1+S2,
the rolling layer extending axially across the entire width of the central annular portion (A) and the under-layer extending axially across the entire width of the central annular portion (A) and across the entire width of each annular shoulder portion (B),
each annular shoulder portion (B) extends axially for a width ranging from 5% to 15% of the width of the tread band and is made of the under-layer for the entire total radial thickness S of the tread band,
wherein the rolling layer comprises a first elastomeric compound characterized by an E′ modulus ranging from 5.00 MPa to 6.50 MPa, and the under-layer comprises a second elastomeric compound characterized by an E′ modulus ranging from 3.50 MPa to 4.60 MPa, and wherein the E′ moduli are measured at 70° C. 10 Hz, using a dynamic device in the tension-compression mode on specimens cross-linked at 170° C. for 10 minutes, and wherein the % ratio between the E′ modulus of the second compound and the E′ modulus of the first compound ranges from 70% to 90%.

15. The tyre according to claim 14, wherein the total radial thickness S of the tread band ranges from 10 mm to 20 mm.

16. The tyre according to claim 14, wherein the thickness S1 of the rolling layer in the central annular portion (A) ranges from 9 mm to 17 mm, and the thickness S2 of the under-layer in the central annular portion (A) ranges from 0.8 mm to 4 mm.

17. The tyre according to claim 14, wherein the central annular portion (A) extends axially for a width ranging from 75% to 85% of the width of the tread band and each annular shoulder portion (B) extends axially for a width ranging from 7.5% to 12.5% of the width of the tread band.

18. The tyre according to claim 14, wherein the % ratio of the E′ modulus of the second compound to the E′ modulus of the first compound ranges from 75% to 90%.

19. The tyre according to claim 14, wherein the difference between the E′ modulus of the first compound and the E′ modulus of the second compound ranges from 0.3 MPa to 2.3 MPa.

20. The tyre according to claim 14, wherein the first elastomeric compound is characterized by an E′ modulus ranging from 5.00 MPa to 6.00 MPa, and the second elastomeric compound is characterized by an E′ modulus ranging from 4.00 MPa to 4.50 MPa.

21. The tyre according to claim 14, wherein the first elastomeric compound is characterized by tan delta ranging from 0.220 to 0.280, and the second elastomeric compound is characterized by tan delta ranging from 0.120 to 0.180, where the tan delta is measured at 70° C. 10 Hz.

22. The tyre according to claim 14, wherein the first elastomeric compound is characterized by a hardness IRHD ranging from 66 to 76, and the second elastomeric compound is characterized by a hardness IRHD ranging from 65 and 71, wherein the IRHD hardnesses are measured at 23° C.

23. The tyre according to claim 14, wherein:
the first elastomeric compound is characterized by a load at 100% elongation CA1 ranging from 1.7 MPa to 2.3 MPa, and a load at 300% elongation CA3 ranging from 7.7 MPa to 10.5 MPa, and
the second elastomeric compound is characterized by a load at 100% elongation CA1 ranging from 1.7 MPa to 2.3 MPa, and a load at 300% elongation CA3 ranging from 8.6 MPa to 11.7 MPa, wherein the loads CA1 and CA3 are measured at 23° C. according to the UNI 6065:2001 standard.

24. The tyre according to claim 14, wherein the first elastomeric compound for the rolling layer comprises a vulcanisable elastomeric composition, wherein the vulcanizable elastomeric composition, before vulcanization, comprises:
from 0 phr to 30 phr of at least one liquid polymer,
from 0 phr to 20 phr of at least one resin,
from 10 phr to 60 phr of at least one plasticising oil,
wherein the sum of the liquid polymer, resin, if present, and plasticising oil ranges from 20 phr to 90 phr,
100 phr of a mixture of solid diene elastomeric polymers, wherein the mixture of polymers comprises:
from 10 phr to 50 phr of at least one solid polybutadiene (BR) having a weight average molecular weight Mw ranging from 300,000 g/mol to 600,000 g/mol and a cis double bonds content of at least 95%,
from 10 phr to 70 phr of at least one emulsion-polymerised solid styrene butadiene copolymer (E-SBR) having a Tg ranging from −60° C. to −20° C., a Mooney viscosity at 160° C. ranging from 30 MU to 70 MU, and a styrene content ranging from 15% to 50%,
from 10 phr to 80 phr of at least one solution-polymerised solid styrene butadiene copolymer (S-SBR), chain-functionalised with multi-branch coupling agents, having one or more of: a weight average molecular weight Mw greater than 500,000 g/mol; an amount of styrene ranging from 25% to 50% and an amount of vinyl ranging from 10% to 50%; a Tg ranging from −50° C. to −20° C.; and a Mooney viscosity at 160° C. ranging from 60 MU to 100 MU,
at least 40 phr of at least one reinforcing filler, and
at least 1.0 phr of at least one vulcanising agent.

25. The tyre according to claim 14, wherein the second elastomeric compound for the under-layer comprises a vulcanizable elastomeric composition, wherein before vulcanization, the vulcanizable elastomeric composition comprises:
from 0 phr to 20 phr of at least one liquid polymer,
from 5 phr to 40 phr of at least one resin,
from 10 phr to 60 phr of at least one plasticising oil,
wherein the sum of the liquid polymer, resin, if present, and plasticizing oil ranges from 15 phr to 120 phr,
100 phr of a mixture of solid diene elastomeric polymers, wherein the mixture of polymers comprises:
10 to 40 phr of at least one solid polybutadiene (BR), with a weight average molecular weight Mw ranging from 200,000 g/mol to 600,000 g/mol and a cis double bonds content of at least 30%,
from 60 phr to 90 phr of at least one end-functionalized, produced in continuous, solution-polymerised solid styrene butadiene copolymer (S-SBR), with one or more of: a weight average molecular weight Mw greater than 500,000 g/mol; an amount of styrene ranging from 25% to 50% and an amount of vinyl between 10% and 70%; a Tg ranging from −50° C. to −10° C.; and a Mooney viscosity at 100° C. ranging from 50 MU to 100 MU,
at least 50 phr of at least one reinforcing filler, and
at least 1.0 phr of at least one vulcanising agent.

26. The tyre according to claim 14, wherein the tyre is for predominantly off-road use.

27. The tyre according to claim 15, wherein the total radial thickness S of the tread band ranges from 12 mm to 16 mm.

28. The tyre according to claim 16, wherein the thickness S1 of the rolling layer in the central annular portion (A) ranges from 11 mm and 15 mm, and the thickness S2 of the under-layer in the central annular portion (A) ranges from 0 1.0 mm and 3 mm.

29. The tyre according to claim 18, wherein the % ratio of the E′ modulus of the second compound to the E′ modulus of the first compound ranges from 80% to 85%.

30. The tyre according to claim 19, wherein the difference between the E′ modulus of the first compound and the E′ modulus of the second compound ranges from 0.6 MPa to 1.1 MPa.

31. The tyre according to claim 20, wherein the first elastomeric compound is characterized by an E′ modulus ranging from 5.00 MPa to 5.50 MPa and the second elastomeric compound is characterized by an E′ modulus ranging from 4.20 MPa to 4.40 MPa.

32. The tyre according to claim 23, wherein:
the first elastomeric compound is characterized by a load at 100% elongation CA1 ranging from 1.9 MPa to 2.1 MPa and a load at 300% elongation CA3 ranging from 8.6 MPa to 9.5 MPa, and
the second elastomeric compound is characterized by a load at 100% elongation CA1 ranging from 1.9 MPa to 2.1 MPa and a load at 300% elongation CA3 ranging from 9.7 MPa to 10.7 MPa, wherein the loads CA1 and CA3 are measured at 23° C. according to the UNI 6065:2001 standard.
